(19) United States
(12) Patent Application Publication
(10) Pub. No.: US 2022/0142270 A1
(43) Pub. Date: May 12, 2022

(54) BREATHING ISOLATION MASK AND BREATHING ASSISTANCE SYSTEM

(71) Applicant: KUNSHAN YUANSHAN TIANDI SOFTWARE TECHNOLOGY CO., LTD., Kunshan Suzhou, Jiangsu (CN)

(72) Inventor: Yixin SUN, Shanghai (CN)

(21) Appl. No.: 17/433,628

(22) PCT Filed: Mar. 30, 2020
(86) PCT No.: PCT/CN2020/082167

§ 371 Date: Aug. 25, 2021

(30) Foreign Application Priority Data
Feb. 26, 2019 (CN) 201910140559.7

(51) Int. Cl. A41D 13/11; A62B 7/12; A62B 18/08

(52) U.S. Cl. CPC A41D 13/1107; A62B 18/084; A62B 7/12; A41D 13/1161

(57) ABSTRACT

Provided are a breathing isolation mask and a breathing assistance system, the breathing isolation mask comprising an isolation mask body, a first gas non-return mechanism, a strap set and a first gas channel, the isolation mask body being provided with an inhalation port and an exhalation port, the inhalation port and the exhalation port being independent from one another or being the same port, the strap set at least comprising two straps, the two straps being respectively connected to two sides of the isolation mask body, the first gas channel extending towards two sides of the isolation mask body, the first gas channel being at least partially connected to at least one of the two straps, one end of the first gas channel at least extending to the inhalation port of the isolation mask body, the first gas non-return mechanism being mounted on the exhalation port or the first gas channel, the first gas non-return mechanism being configured to allow gas to unidirectionally exit the isolation mask from the exhalation port or via the first gas channel. The first gas channel is not suspended below the isolation mask, and when connected to the strap set, is not prone to swaying, or interfering with daily activities of a user.

### CROSS-REFERENCE TO RELATED APPLICATION

The present disclosure claims priority of Chinese patent application with the filing number 201 91 01 405597 filed on Feb. 26, 2019 with the Chinese Patent Office, and entitled “Breathing Isolation Mask and Breathing Assistance System”, the contents of which are incorporated herein by reference in entirety.

### TECHNICAL FIELD

The present disclosure relates to the field of respiratory equipment, in particular to a breathing isolation mask and a breathing assistance system.

### BACKGROUND ART

Traditional masks (or face masks) cover the mouth area, and has a long gas transmission tube extending out, which will hinder the user's speaking and eating activities, thereby affecting the user's original daily activities and causing great inconvenience to the user after wearing the mask.

It is difficult for the edges of traditional masks to fit a person's face perfectly, and there will be air leakage vents where they do not fit the face, wherein when the human inhales, because the resistance in the case that the outside air is inhaled from the air leakage vents at the edge is smaller than that in the case that the air is filtered through the mask and then inhaled, the unpurified air will enter the human respiratory system through the air leakage vents, thereby reducing the air purifying effect of the mask. The user may feel at ease after wearing the mask, but the actual situation may be that he has inhaled a lot of unpurified air without noticing it.

For breathing masks, an air inlet tube is generally connected at the bottom end of the mask, which will cause inconvenience in movement after wearing the mask.

### SUMMARY

One of the objectives of the present disclosure is to provide a breathing isolation mask, which can be used as a device to provide a user with purified air.

Another object of the present disclosure is to provide a breathing assistance system that can more conveniently provide purified air to the user.

In order to solve at least one of the above technical problems, the present disclosure provides the following technical solution:

a breathing isolation mask, the breathing isolation mask comprising an isolation mask body, a first gas non-return mechanism, a strap group and at least one first gas tube.

Optionally, the isolation mask body is made of a material capable of isolating gas, and the isolation mask body is provided with an inhalation port and an exhalation port, wherein the inhalation port and the exhalation port are independent from each other or are the same port.

The strap group at least comprises two straps, wherein the two straps are respectively connected to two sides of the isolation mask body.

The first gas tube extends towards two sides of the isolation mask body, the first gas tube is at least partially connected to at least one of the two straps, and one end of the first gas tube at least extends to the inhalation port of the isolation mask body.

For the first gas non-return mechanism, the first gas non-return mechanism is mounted on the exhalation port or the first gas tube connected with the inhalation port, and the first gas non-return mechanism is configured to allow gas to unidirectionally exit the isolation mask body from the exhalation port or be discharged from the isolation mask body via the first gas tube connected with the inhalation port.

Optionally, in an optional embodiment of the present disclosure, the strap is in a flexible tubular structure or a belt-like structure, and the first gas tube is at least partially embedded in at least one of the two straps.

Optionally, in an optional embodiment of the present disclosure, the strap is in a flexible mesh structure, and the strap is wound on the outside of the first gas tube.

Optionally, in an optional embodiment of the present disclosure, the cross section of at least one segment of the first gas tube is in a flat shape, and the cross section of a segment of the first gas tube close to the inhalation port is in a flat shape.

Optionally, in an optional embodiment of the present disclosure, the cross section of the segment of the first gas tube close to the inhalation port is elliptical or approximately elliptical.

Optionally, in an optional embodiment of the present disclosure, at least one segment of the first gas tube is provided with at least two gas channels, and the two gas channels are arranged side by side.

Optionally, in an optional embodiment of the present disclosure, at least two first gas tubes are embedded in the same strap, and the two first gas tubes are arranged in parallel to each other.

Optionally, in an optional embodiment of the present disclosure, a part of the strap, from an end close to the isolation mask body to a position at a preset distance away from the isolation mask body, is wrapped outside the first gas tube; and at the position on the strap which is at the preset distance away from the isolation mask body, the first gas tube extends out of the strap.

Optionally, in an optional embodiment of the present disclosure, the isolation mask body is made of airtight hard material or soft material or a combination of the two materials.

Optionally, in an optional embodiment of the present disclosure, the isolation mask body may only cover the nose area.

Optionally, in an optional embodiment of the present disclosure, the breathing isolation mask further comprises a second gas tube, multiple first gas tubes are provided, and the second gas tube is connected to the first gas tubes.

Optionally, in an optional embodiment of the present disclosure, the edge of the isolation mask body is connected with a circle of an elastic soft sealing structure.

Optionally, in an optional embodiment of the present disclosure, the sealing structure is in a turn-out structure.

Optionally, in an optional embodiment of the present disclosure, the strap group comprises one strap or two independent straps; and when the strap group comprises one strap, at least a part of the strap has elasticity.

Optionally, in an optional embodiment of the present disclosure, the inhalation port and the exhalation port are the same port, the isolation mask body is connected to the first gas tube through the same port, and the first gas non-return mechanism is mounted on one end of the first gas tube close to the isolation mask body, so that the gas unidirectionally exit the isolation mask body.

Optionally, in an optional embodiment of the present disclosure, the first gas non-return mechanism comprises a first non-return body and a second non-return body;

the elastic modulus of the first non-return body is greater than the elastic modulus of the second non-return body; and optionally, the first non-return body is made of a rigid material, and the second non-return body is made of a flexible material;

the first non-return body is provided with at least one first through hole, and the second non-return body is provided with at least one second through hole;

when the gas flows in a different direction, at least part of the first non-return body and at least part of the second non-return body can move relative to each other;

when the gas flows in the direction of exiting the isolation mask body, there is a gap between the first non-return body and the second non-return body, and the gap is in communication with both the at least one first through hole and the at least one second through hole, so that the gas may exit the isolation mask body; and

when the gas flows in the direction of flowing into the isolation mask body, all the first through holes are blocked by the second non-return body, and/or all the second through holes are blocked by the first non-return body.

For a breathing assistance system, the breathing assistance system comprises a gas supply device, a second gas non-return mechanism, and the above-mentioned breathing isolation mask, the first gas tube is connected to the gas output port of the gas supply device, the second gas non-return body is mounted on the first gas tube, and the second gas non-return mechanism is configured to unidirectionally introduce the gas of the gas supply device into the isolation mask body.

Optionally, in an optional embodiment of the present disclosure, the gas supply device comprises an air storage tank for storing purified air or an air purification device.

Optionally, in an optional embodiment of the present disclosure, the breathing assistance system further includes a buffer airbag, which is in communication with the first gas tube; and the buffer airbag is mounted on the gas supply device, or mounted on other supply channels located between the inlet end of the second gas non-return mechanism and the gas supply device, so that when the second gas non-return mechanism is closed, the gas discharged from the gas supply device may enter the buffer airbag.

Optionally, in an optional embodiment of the present disclosure, the buffer airbag is made of a flexible and airtight material.

Optionally, in an optional embodiment of the present disclosure, the buffer airbag is made of an elastic material.

Optionally, in an optional embodiment of the present disclosure, the breathing assistance system further comprises a non-elastic protective mask with a preset volume, the non-elastic protective mask is sleeved outside the buffer airbag to limit the maximum expansion volume of the buffer airbag, and the non-elastic protective mask is made of a breathable or airtight material.

Optionally, in an alternative embodiment of the present disclosure, the breathing assistance system further comprises a non-elastic airbag with a preset volume, the non-elastic airbag is accommodated in the buffer airbag, the non-elastic airbag is in communication with the first gas tube, and non-elastic airbag is made of a flexible non-elastic material.

The beneficial effects of the embodiments of the present disclosure may include the follows.

For the breathing isolation mask obtained by the above-mentioned design in the present disclosure, when in use, the first gas tube on the breathing isolation mask is connected with the gas supply device, and the breathing isolation mask is worn on the face to only cover the nose area. Since the first gas tube extends toward both sides of the isolation mask body, and the first gas tube is at least partially connected to at least one of the two straps, the first gas tube is enabled to be not suspended below the isolation mask, wherein especially when the first gas tube is connected to the strap, the first gas tube is more stable, and not prone to swaying and interfering with the original daily activities of a user, or when the first gas tube is optionally embedded in the strap, not only the aforementioned purposes can be achieved, but also it is lighter, simpler and more beautiful.

### BRIEF DESCRIPTION OF DRAWINGS

FIG. 1 is a schematic view of a breathing isolation mask provided by an embodiment of the present disclosure after being worn on the head of a user;

FIG. 2 is a schematic view of the breathing isolation mask provided by an embodiment of the present disclosure;

FIG. 3 is a schematic view of the connection between the first gas tubes and the second gas tube of the breathing isolation mask provided by an embodiment of the present disclosure;

FIG. 4 is a sectional view taken along IV-IV of FIG. 3;

FIG. 5 is a schematic cross-sectional view of the breathing isolation mask provided by an embodiment of the present disclosure in an inhalation stage;

FIG. 6 is a schematic cross-sectional view of the breathing isolation mask provided by an embodiment of the present disclosure in an exhalation stage, wherein the sealing structure is in a turn-out structure;

FIG. 7 is a schematic cross-sectional view of a first gas tube of the breathing isolation mask provided by an embodiment of the present disclosure in an inhalation stage;

FIG. 8 is a schematic cross-sectional view of a first gas tube of the breathing isolation mask provided by an embodiment of the present disclosure in an exhalation stage;

FIG. 9 is a schematic view of a first gas tube with the cross section in a flat shape provided by an embodiment of the present disclosure;

FIG. 10 is a schematic view of another breathing isolation mask provided by an embodiment of the present disclosure after being worn on the head of a user, wherein a decorative part is connected around the isolation mask body;

FIG. 11 is a schematic cross-sectional view of another isolation mask body of the breathing isolation mask provided by an embodiment of the present disclosure, wherein the sealing structure is in an inwardly-turning structure;

FIG. 12 is a schematic cross-sectional view of a first gas non-return mechanism provided by an embodiment of the present disclosure in a first state; and

FIG. 13 is a schematic cross-sectional view of the first gas non-return mechanism provided by an embodiment of the present disclosure in a second state.

In the drawing: 100—breathing isolation mask; 110—isolation mask body; 120—strap; 130—first gas tube; 140—second gas tube; 150—sealing structure; 210—first gas non-return mechanism; 211—first non-return body; 212—second non-return body; 213—first through hole; 214—second through hole; 215—gap; 216—baffle; 220—inhalation port; 230—exhalation port; 240—second gas non-return mechanism.

### DETAILED DESCRIPTION OF EMBODIMENTS

In order to make the objectives, technical solutions and advantages of the embodiments of the present disclosure clearer, the technical solutions in the embodiments of the present disclosure will be described clearly and completely below in conjunction with drawings in the embodiments of the present disclosure. Obviously, the described embodiments are a part of the embodiments of the present disclosure, rather than all of the embodiments. Therefore, the following detailed description of the embodiments of the present disclosure provided in the drawings is not intended to limit the claimed scope of the present disclosure, but only represents selected embodiments of the present disclosure. Based on the embodiments in the present disclosure, all other embodiments obtained by those ordinary skilled in the art without creative work shall fall within the protection scope of the present disclosure.

In the description of the present disclosure, unless otherwise definitely specified, the terms “first” and “second” are only used for descriptive purpose, and cannot be understood as indicating or implying importance in relativity or implicitly indicating the quantity of the indicated technical features. Thus, the features defined with “first” and “second” may explicitly or implicitly include one or more of these features. In the description of the present disclosure, “plurality” means two or more, unless otherwise definitely specified. In the present disclosure, unless otherwise definitely specified and limited, the terms “mount”, “link”, “connect” and “fix” and other terms should be understood in a broad sense, for example, they can be fixed connection, detachable connection or integrated connection; they can be directly connection or indirectly connection by intermediate medium; they can be the internal communication between two components or the interaction between two components. For those ordinarily skilled in the art, the specific meaning of the above terms in the present disclosure can be understood according to the specific situation.

In the present disclosure, unless otherwise definitely specified and limited, the first feature being “on” or “under” the second feature may include that the first feature is in direct contact with the second feature, or that the first feature and the second feature are not in direct contact with each other but in contact through other features between them. Moreover, the first feature being “on”, “above” and “over” the second feature includes that the first feature is directly above or obliquely above the second feature, or only represents that the horizontal height of the first feature is higher than that of the second feature. The first feature is “under”, “below” and “underneath” the second feature, includes that the first feature is directly below or obliquely below the second feature, or only represents that the horizontal height of the first feature is less than that of the second feature.

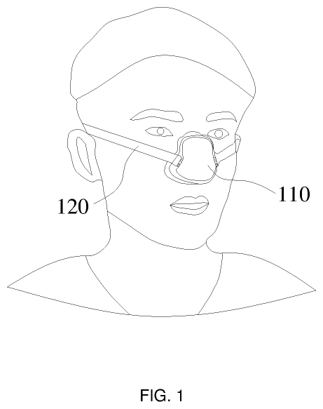

Referring to FIG. 1 to FIG. 13, the embodiments of the present disclosure are shown.

The inventor found that one gas inlet tube connected at the bottom end of a mask for inputting clean air for breathing will cause that the user's daily activities such as speaking and eating is affected after the mask is worn, resulting in inconvenience, lead to relatively large volume of entire mask, which affects the beauty of the face. In addition, the weight of the entire mask is relatively heavy, since the weight of the human head is supported by the cervical spine, the increase in the weight of the items worn on the head will become a burden on the cervical spine, such that wearing for a long time will become an unbearable weight for the users, and the user has to give up the long-term wearing and using of the mask, and further the users can not benefit from the clean air provided by the mask for a long time, posing a breathing risk. Therefore, it is urgent to develop a lightweight simple breathing isolation mask with good wearing experience. The isolation mask can provide clean air to the user's respiratory system, and the isolation mask can reduce the impact and hindrance on the user's original daily activities to a smaller extent during the entire wearing of the isolation mask, and even enable the user to be in a state of feeling no wearing during the entire using and wearing of the isolation mask, so that the user wears the breathing isolation mask but does not seem to feel wearing it, has flexible and free movement, and the user's daily activities and work such as speaking, eating, running, body building, physical labor, and medical affairs are not affected, which will bring great convenience to users, and it is because of the convenience that the users are willing to wear and use for a long time, so that the user's respiratory system can benefit from the clean air for a long time, and ultimately the effects of the user obtaining respiratory health and preventing respiratory diseases from infecting themselves are achieved.

As shown in FIG. 1, the embodiment of the present disclosure provides a breathing isolation mask 100, which comprises an isolation mask body 110, a first gas non-return mechanism 210 (see FIG. 5), a strap group and first gas tubes 130 (see FIG. 5).

Optionally, the isolation mask body 110 may be made of a material capable of isolating gas, and the material may be a hard material or a soft material or a combination of the two materials. Optionally, for example, the isolation mask body 110 may be made of plastic, or a fabric that is difficult to be breathable or airtight, or a mixture of plastic and fabric.

Optionally, in some embodiments, the inhalation port(s) 220 and the exhalation port 230 may be provided in the isolation mask body 110 independently from one another, as shown in FIG. 5 and FIG. 6, the isolation mask body 110 may be provided with the inhalation ports 220 and the exhalation port 230, and the inhalation ports 220 and the exhalation port 230 may be arranged to be separated from one another. When the user wears the isolation mask body 110 in the nose area, the isolation mask body 110 and the facial skin can be combined to form a relatively sealed cavity, which is defined by the inner surface of the isolation mask body 110 and the facial skin. The inhalation port 220 refers to the opening where gas enters the cavity when the user inhales, and the exhalation port 230 refers to the opening where the gas exits from the cavity when the user exhales. Optionally, the first gas non-return mechanism 210 may be installed at the exhalation port 230, and the first gas non-return mechanism 210 may be configured to allow gas to unidirectionally exit the isolation mask body 110 from the exhalation port 230. Optionally, the first gas non-return mechanism 210 may be arranged to cover the exhalation port 230 from the outer surface (which is opposite to the inner surface of the isolation mask body 110 that defines the aforementioned cavity) of the isolation mask body 110, or be arranged to be located in the exhalation port 230. Optionally, when the user inhales (refer to FIG. 5), the first gas non-return mechanism 210 may be in a closed state, which is equivalent to that the exhalation port 230 is closed, and only the inhalation ports 220 are open; and when the user exhales (refer to FIG. 6), the first gas non-return mechanism 210 may be in an open state, and the exhaust gas exhaled by the user may be directly discharged from the exhalation port 230 on the isolation mask body 110 to the outside atmosphere.

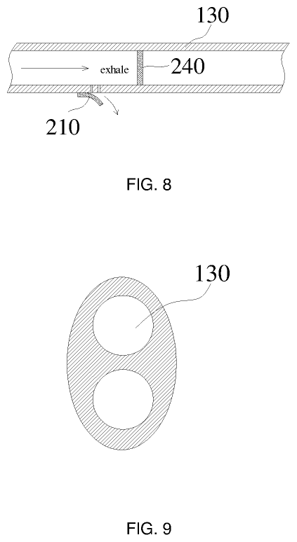

Optionally, in other embodiments, the inhalation port 220 and the exhalation port 230 may also be the same port, so that the gas enters and exits the isolation mask body 110 from the same port, for example, referring to FIG. 7 and FIG. 8, the second gas non-return mechanism 240 may be installed in the first gas tube 130 (the left end is connected to the isolation mask body 110, and the right end is connected to the gas source), and the first gas non-return mechanism 210 may be installed on the sidewall of the first gas tube 130. Optionally, the first gas non-return mechanism 210 may be installed at an end of the first gas tube 130 close to the isolation mask body 110, and the first gas non-return mechanism 210 may be closer to the isolation mask body 110 than the second gas non-return mechanism 240, and the first gas non-return mechanism 210 and the second gas non-return mechanism 240 may be separated from each other. In other words, the first gas non-return mechanism 210 may be installed on the sidewall of the first gas tube 130 and located between the isolation mask body 110 and the second gas non-return mechanism 240. When the user inhales (refer to FIG. 7), the second gas non-return mechanism 240 installed in the first gas tube 130 can be opened and the first gas non-return mechanism 210 installed on the sidewall of the first gas tube 130 can be closed (at this time, the first gas tube 130 may be equivalent to a traditional airtight tube), and the gas can enter the isolation mask body 110 through the first gas tube 130. When the user exhales (refer to FIG. 8), the second gas non-return mechanism 240 installed in the first gas tube 130 can be closed (blocking the passage to the gas source) and first gas non-return mechanism 210 installed on the sidewall of the first gas tube 130 may be open (at this time, a part of the first gas tube 130 adjacent to the isolation mask body 110 may allow the gas to pass through to reach the outside atmosphere), the gas may be discharged from the isolation mask body 110 to the outside atmosphere through the first gas tube 130. By arranging the first gas non-return mechanism 210 on the first gas tube 130, the volume and weight of the isolation mask body 110 can be greatly reduced, and the use burden of the wearer can be reduced.

Optionally, in other embodiments of the present disclosure, there may be a plurality of first gas non-return mechanisms 210, and the first gas non-return mechanisms 210 may be installed at the exhalation port 230 and the first gas tube(s) 130 at the same time.

Optionally, in the embodiments shown in FIG. 5 and FIG. 6, the number of the inhalation ports 220 may be two, and the number of exhalation ports 230 may be one. Optionally, in other embodiments, the number of inhalation ports 220 may also be one or three or more. For example, two inhalation ports 220 may be combined into one port; and in other embodiments, the number of exhalation ports 230 can also be two or more. The present disclosure does not limit whether the exhalation port 230 and the inhalation port 220 are independently provided, or whether they are combined into the same port.

Optionally, in this embodiment, the strap group may include at least two sections of straps 120, and the two sections of straps 120 may be respectively connected to two sides of the isolation mask body 110. When in use, the isolation mask body 110 can be fixed at the nose area through the straps 120. Optionally, the two sections of straps 120 may be located at the same strap 120, or may be located at different straps 120 respectively.

Optionally, in an optional embodiment of the present disclosure, the strap group may include one strap 120 or two independent straps 120, wherein when the strap group includes one strap 120, at least a portion of the strap 120 may be elastic. Optionally, when there is only one strap 120, two ends of the strap 120 can be connected to the two sides of the isolation mask body 110 respectively, and in this case, at least a portion of the strap 120 needs to be elastic, so that the strap 120 can be fixed on the head by elastic contraction. Optionally, when there are two straps 120, the two straps 120 may be connected to two sides of the isolation mask body 110 respectively. Optionally, the two straps 120 can both be flexible and can be knotted each other to form a connection structure, or in some embodiments, the two straps 120 can be detachably connected to each other through a quick-release structure such as magic tapes, plastic buckles, metal buckles and the like. Optionally, the number of the straps 120 can also be three or more.

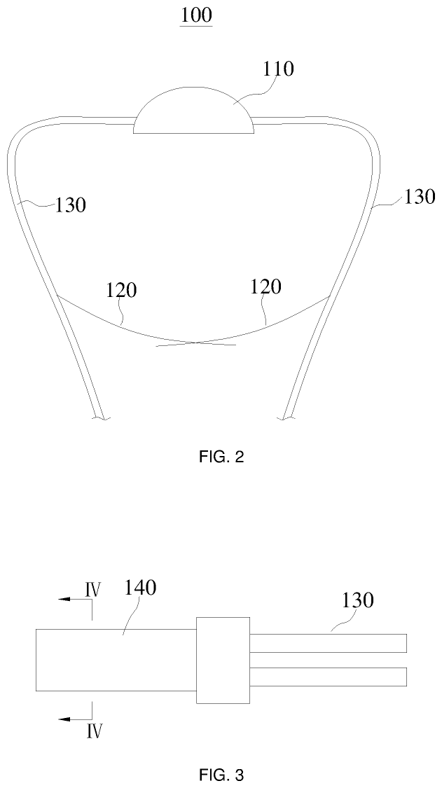

As shown in FIG. 1 and FIG. 2, the first gas tube 130 may extend toward both sides of the isolation mask body 110, and the first gas tube 130 may be at least partially connected to at least one of the two straps 120, one end of the first gas tube 130 may extend at least to the inhalation port 220 of the isolation mask body 110. Optionally, along the length direction of the first gas tube 130, the first gas tube 130 may have the entire segment connected to the strap 120, or a portion connected to the strap 120. Optionally, the first gas tubes 130 may have some end portions extending to the inhalation port 220 of the isolation mask body 110, or some portions connected to a gas supply device or a pipe of gas supply device. Optionally, the end portions extending to the inhalation port 220 may also extend inwardly without affecting the use, for example, it may extend along the inner wall of the isolation mask body 110.

Optionally, regarding the positional relationship between the first gas tube 130 and the strap 120, them may be arranged side by side. Optionally, one of them may cover the other, or one of them may partially or completely wrap the other. Optionally, when arranged side by side, the first gas tube 130 and the strap 120 may be attached to or spaced from each other. Overall, the extension directions of the two are consistent at least near the isolation mask body 110, while the extension directions of the two can be consistent or inconsistent at the position far away from the isolation mask body 110. For example, the inconsistent situation may be that the end portions of the two straps 120 away from the isolation mask body 110 are connected to each other at the back of the head, and the portion of the first gas tube 130 that is away from the isolation mask body 110 can be separated from the strap 120 in the vertical direction, and close to the neck or shoulder of the user.

Optionally, in an optional embodiment of the present disclosure, the strap 120 may be in a flexible tubular structure or a belt structure, and the first gas tube 130 may be at least partially embedded in at least one of the two straps 120. On the one hand, the strap 120 of the tubular structure or belt structure can fix the first gas tube 130 relatively firmly, and on the other hand, the first gas tube 130 can be hidden at least to a certain extent.

Optionally, in an optional embodiment of the present disclosure, the strap 120 may be in a flexible mesh structure, and the strap 120 may be wound around the outside of the first gas tube 130. Optionally, the strap 120 may be wound on the outer surface of the first gas tube 130 in the form of a helical line, or other winding manners may be used. This method not only facilitates the connection between the strap 120 and the first gas tube 130, but also facilitates hiding of the first gas tube 130.

Optionally, in an optional embodiment of the present disclosure, when the first gas tube 130 is partially embedded in the strap 120 or wound by the strap 120, the first gas tube 130 may extend out of the strap 120 from an end of the strap 120 away from the isolation mask body 110. In this way, the end of the strap 120 away from the isolation mask body 110 can be used as a common strap 120, and the first gas tube 130 can be easily guided to other places, such as the back of the user.

Optionally, in an optional embodiment of the present disclosure, the strap 120 may be an integral structure with the first gas tube 130, for example, a gas channel may be formed inside the flexible strap 120 by an injection molding process or the like, the strap 120 can be used not only for binding and fixing, but also as the first gas tube 130. Optionally, in some embodiments, the strap 120, the first gas tube 130, and the isolation mask body 110 may be integrally formed.

Optionally, in an optional embodiment of the present disclosure, as shown in FIG. 2, one end of each first gas tube 130 may be connected to the isolation mask body 110, and a part of the first gas tube 130 away from the isolation mask body 110 may be connected with the strap 120. In this embodiment, the problem that the first gas tube 130 is inconvenient to be tied and connected is overcome by using the two straps 120 to fix the breathing isolation mask 100, and for the part of the first gas tube 130 close to the isolation mask body 110, a decorative layer may be optionally coated or pasted on its surface.

Optionally, in an optional embodiment of the present disclosure, the cross section of at least one segment of the first gas tube 130 may be in a flat shape, and the segment of the first gas tube 130 with the cross section in the flat shape may be close to the inhalation port 220. The flat structure is more conductive to fit the facial skin, and can also increase the comfort of the user. Optionally, the cross section of the entire first gas tube 130 may be in the flat shape, or the cross section of only one segment may be flat, for example, only the part that will come into contact with the skin when being worn may have the cross section in the flat shape, while other parts can be flat or tubular. The flat shape means that the width of the cross section of the first gas tube 130 in one direction is greater than the width thereof in other direction, for example, the first gas tube 130 may have a rectangular cross section or an elliptical cross section and the like. Referring to FIG. 9, the cross section of the first gas tube 130 shown is elliptical.

Optionally, in an optional embodiment of the present disclosure, the cross section of a segment of the first gas tube 130 close to the inhalation port 220 may be elliptical or approximately elliptical.

Optionally, in an optional embodiment of the present disclosure, at least one segment of the first gas tube 130 may have at least two gas channels, which may be arranged side by side. Arrangement of the two gas channels side by side is more convenient to form a flat structure. If there is only one gas channel, when it is made into a flat structure, higher requirements are required for the first gas tube 130, for example, the ability to keep the shape unchanged is required.

Optionally, in an optional embodiment of the present disclosure, at least two first gas tubes 130 may be embedded in the same strap 120, and the two first gas tubes 130 may be arranged in parallel. Optionally, in an optional embodiment of the present disclosure, the first gas non-return mechanism 210 may comprise a non-return structure, and the non-return structure may be a non-return structure of a swing type structure, a non-return structure of a piston type structure and the like.

At least one of the numerous embodiments of the first gas non-return mechanism 210 in the present disclosure will be introduced below.

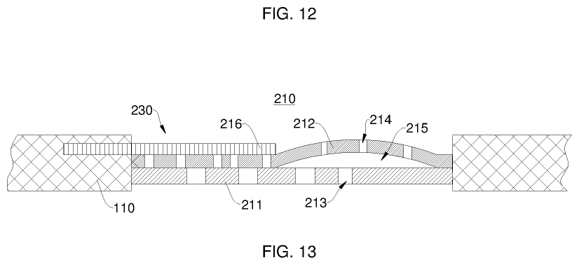

Please refer to FIG. 5, FIG. 6, FIG. 12 and FIG. 13. FIG. 12 and FIG. 13 are schematic views of the exhalation phase.

As described above, the first gas non-return mechanism 210 may be mounted on the exhalation port 230, and the first gas non-return mechanism 210 may be configured to allow gas to unidirectionally exit the isolation mask body 110 from the exhalation port 230.

Optionally, in this embodiment, the first gas non-return mechanism 210 may comprise a first non-return body 211 and a second non-return body 212; the first non-return body 211 and the second non-return body 212 may be arranged such that the first non-return body 211 is closer to the inner surface (which defines a relatively sealed cavity when the isolation mask body 110 is combined with the facial skin) of the isolation mask body 110 than the second non-return body 212, that is, the first non-return body 211 can be arranged between the second non-return body 212 and the inner surface of the isolation mask body 110; both the first non-return body 211 and the second non-return body 212 can be hermetically connected with the surrounding wall of the exhalation port 230 (such as welding, bonding, clamping and other connection methods), which can avoid gas leakage from the edges of the first non-return body 211 and the second non-return body 212.

Optionally, in this embodiment, the first non-return body 211 and the second non-return body 212 may be in a sheet shape, and the elastic modulus of the first non-return body 211 may be greater than that of the second non-return body 211. Optionally, the first non-return body 211 can be made of a rigid material, such as stainless steel, aluminum, copper, nickel, plastic, ABS plastic, alloy, medical plastic, carbon fiber, plexiglass, glass, ceramic and the like; and the second non-return body 212 may be made of a flexible material, such as silica gel, polyethylene, polypropylene, polyvinyl alcohol film, polypropylene, polyester, nylon, resin film, polyvinyl chloride, polystyrene, and the like.

The elastic modulus of the first non-return body 211 is greater than the elastic modulus of the second non-return body 212, therefore, when the gas exerts the same force on the first non-return body 211 and the second non-return body 212 in the positive direction (in this embodiment, the direction in which the gas exits the isolation mask body 110 is the positive direction), the deformation of the second non-return body 212 can be greater than that of the first non-return body 211, the second non-return body 212 can be away from the first non-return body 211 in the positive direction, so that a gap 215 may be formed between the second non-return body 212 and the first non-return body 211. On the contrary, when the gas exerts the same force on the first non-return body 211 and the second non-return body 212 in the reverse direction (in this embodiment, the direction in which the gas flows into the isolation mask body 110 is the reverse direction, and the reverse direction is opposite to the positive direction), the second non-return body 212 can approach the first non-return body 211 in the reverse direction, so that the second non-return body 212 and the first non-return body 211 may be attached to each other, and there is no gap 215 between the two.

Optionally, the first non-return body 211 may be provided with at least one first through hole 213, the first through hole 213 may penetrate through the first non-return body 211, the second non-return body 212 may be provided with at least one second through hole 214, the second through hole 214 may penetrate through the second non-return body 212. Optionally, in the embodiment of the present disclosure, the first through hole 213 and the second through hole 214 may be of appropriate shape and size.

Optionally, when the gas flows in a different direction, at least part of the first non-return body 211 and at least part of the second non-return body 212 can move relative to each other, such that the exhalation port 230 can be opened in the exhalation phase and closed in the inhalation phase.

Optionally, when the gas flows at the position of the exhalation port 230 along the direction in which the gas is discharged from the isolation mask body 110, there may be a gap 215 between the first non-return body 211 and the second non-return body 212, and the gap 215 may be communicated with at least one first through hole 213 and at least one second through hole 214, such that the gas can be discharged from the isolation mask body 110.

Optionally, when the gas flows at the position of the exhalation port 230 along the direction in which the gas flows into the isolation mask body 110, all the first through holes 213 may be blocked by the second non-return body 212, and/or all the second through holes 214 can be blocked by the first non-return body 211, such that the gas cannot flow into the isolation mask body 110.

In other words, when the gas flows at the position of the exhalation port 230 along the direction in which the gas is discharged from the isolation mask body 110 (for example, in the exhalation phase), the gap 215 may be communicated with at least one first through hole 213 and at least one second through hole 214, the exhalation port 230 can be opened, and the exhaled gas can be discharged through the first gas non-return mechanism 210.

When the gas flows at the position of the exhalation port 230 along the direction in which the gas flows into the isolation mask body 110 (for example, in the inhalation phase), the second non-return body 212 and the first non-return body 211 may be attached to each other, so that all the first through holes 213 are blocked, or all the second through holes 214 are blocked, or all the first through holes 213 and all the second through holes 214 are blocked, making external gas cannot flow into the isolation mask body 110. This prevents the exhaled exhaust gas from flowing into the isolation mask body 110 in the inhalation phase. Optionally, after the second non-return body 212 and the first non-return body 211 are attached to each other, the first through holes 213 and the second through holes 214 can be arranged in a mutually “staggered” arrangement, and the first gas non-return mechanism 210 achieves the purpose of non-return.

Through the cooperation of the first non-return body 211 and the second non-return body 212, the first gas non-return mechanism 210 can effectively control the unidirectional outflow of gas from the exhalation port 230. It can prevent the exhaled exhaust gas from flowing into the exhalation port 230 again, and prevent the external unpurified air from flowing into the exhalation port 230; in addition, the first non-return body 211 and the second non-return body 212 can be installed at the exhalation port 230 with a cross section in any shape, which is convenient for installation, and the first non-return body 211 and second non- return body 212 may be made to be of any curved shapes that can be attached to each other, facilitating application.

Optionally, in this embodiment, the first gas non-return mechanism 210 may further comprise a baffle 216, which may be slidably connected with the second non-return mechanism 212, the baffle 216 may be arranged to be farther from the first non-return body 211 than the portion of the second non-return body 212 that is slidably connected with the baffle 216, that is, the portion of the second non-return body 212 that is slidably connected with the baffle 216 may be located between the baffle 216 and the first non-return body 211. Optionally, the baffle 216 may be configured in such a way that the baffle 216 slides so that the baffle 216 can block a part of at least one second through hole 214. Optionally, in this embodiment, the sliding manner of the baffle 216 and the second non-return body 212 may adopt multiple manners such as a sliding rail, a sliding groove and the like.

Optionally, the sliding connection between the baffle 216 and the second non-return body 212 may at least have the following advantages.

When the first gas non-return mechanism 210 is opened (for example, in the exhalation phase), the baffle 216 can adjust the number of the second through holes 214 through which the gas can flow in the second non-return body 212, so as to adjust the flow rate of gas passing through the first gas non-return mechanism 210, or adjust the difficulty degree of the gas passing through the first gas non-return mechanism.

When changing from the exhalation phase to the inhalation phase, because of the negative pressure inside the breathing isolation mask 100, the gas outside the exhalation port 230 has a movement tendency to flow into the isolation mask body 110, the gas can exert a force on the second non-return body 212 to make the second non-return body 212 approach the first non-return body 211 until all the second through holes 214 are blocked. The force exerted by the gas on the second non-return body 212 may be related to the pressure intensity of the gas, and related to the action area of the gas and the second non-return body 212.

Sliding the baffle 216 enables the baffle 216 to block a part of the at least one second through hole 214. Correspondingly, the baffle 216 can optionally block one or more second through holes 214, when the number of second through holes 214 blocked by the baffle 216 is large, the action area of the gas and the second non-return body 212 is reduced; when changing from the exhalation phase to the inhalation phase, less counter-flow gas can make the second non-return body 212 approach the first non-return body 211 so that all the second through holes 214 are blocked. Therefore, in the process of changing from the exhalation phase to the inhalation phase, the volume of the exhaust gas returning from the second through hole 214 is smaller, which can increase the non-return effect of the first gas non-return mechanism 210, and can prevent more exhaust gas or external unpurified air from being sucked into the isolation mask body 110 at the same time.

When the user is in an exercise state, the breathing rhythm speeds up, the baffle 216 can be slid to make more second through holes 214 or even all the second through holes 214 in an unblocked state, and the gas enhaled when the user exhales is easier to be discharged from the breathing isolation mask 100. Since rapid ventilation is required during exercise, more second through holes 214 in an unblocked state can achieve the purpose of rapid ventilation. Furthermore, the user can adjust the number of the second through holes 214 blocked by the baffle 216 according to the amount of activity of the user, so as to obtain the best use effect.

Optionally, in an optional embodiment of the present disclosure, the isolation mask body 110 may be made of an airtight hard material or soft material, or a combination of the two materials. Optionally, the isolation mask can be made of only hard material, or only soft material, or a combination of hard material and soft material.

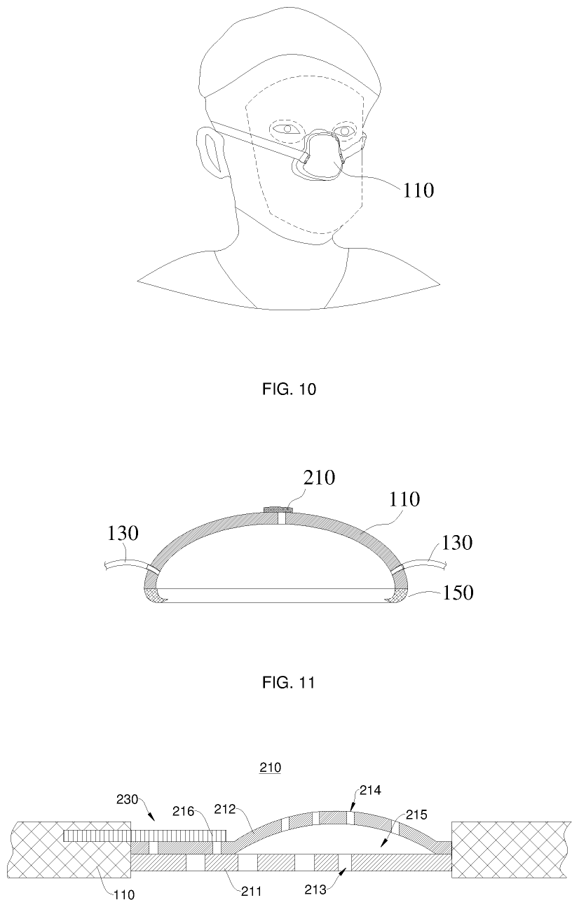

Optionally, in an optional embodiment of the present disclosure, the isolation mask body 110 can only cover the nose area. Please refer to FIG. 1, when the isolation mask can only cover the nose area, the size of the isolation mask can be smaller and easier to carry, in addition, since such isolation mask does not cover the mouth, it is convenient for users to speak, eat, run, exercise/body building, physical labor, medical work and other daily activities and work. Optionally, in other embodiments, other decorative bodies of the isolation mask can cover various areas of the face to play a decorative role. The area within the dotted line close to the isolation mask body 110 in FIG. 10 can be referred to, to represent other decorative bodies which can cover various areas of the face to play a decorative role. Optionally, since only the nose area is covered, the volume of the isolation mask body 110 may be smaller and the weight may be lighter.

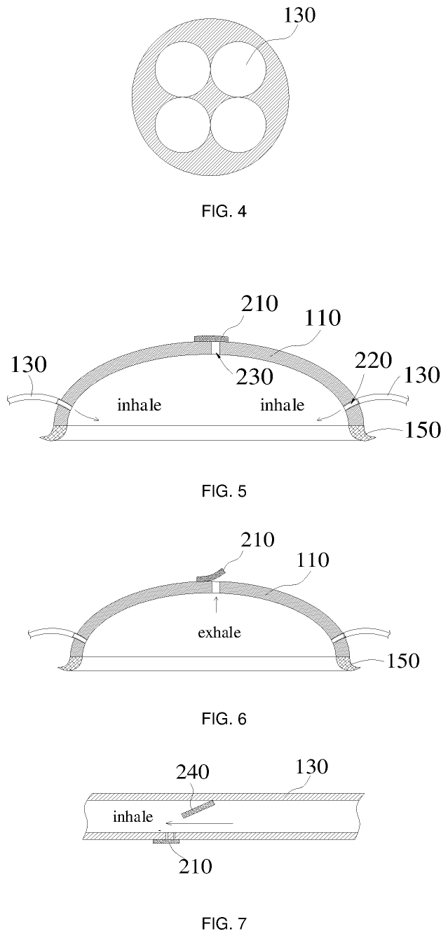

Optionally, in an optional embodiment of the present disclosure, as shown in FIG. 3 and FIG. 4, the breathing isolation mask 100 may further comprise a second gas tube 140, multiple first gas tubes 130 may be provided, and the second gas tube 140 may be connected with the first gas tubes 130. The multiple first gas tubes 130 may be converged to one second gas tube 140, and the second gas tube 140 may be used to connect a gas supply device or a tube of the gas supply device. Optionally, there may also be two or more second gas tubes 140.

If the sealing ring used on the edge of the isolation mask contacting the face uses an inwardly curved structure, when inhaling, the internal air pressure is low, and the external air pressure is high, and if the tension of the strap 120 is small, the inward curved structure of the sealing ring may cause some unpurified air from outside to leak in, which poses a breathing risk to the user.

Optionally, in an optional embodiment of the present disclosure, as shown in FIG. 5, the edge of the isolation mask body 110 is connected with a circle of elastic soft sealing structure 150. The elastic soft sealing structure 150 is conductive to fit the skin surface, and has a better sealing effect, and the sealing structure 150 can at least prevent to a certain extent external unpurified gas from being sucked into the isolation mask body 110.

Optionally, in an optional embodiment of the present disclosure, the sealing structure 150 may be a turn-out structure, the so-called turn-out structure refers to that the edge of the sealing ring extends along the facial skin to the periphery of the mask after the mask is in contact with the facial skin, instead of extending into the cavity defined by the mask and the face. Optionally, the sealing structure 150 may be in a sheet structure and bendable, for example, the cross section may be approximately crescent-shaped, and when wearing, the arc surface of the sealing structure 150 may fit the skin, and the edge of the sealing structure 150 may face outward.

When the sealing ring uses the turn-out structure, the outwardly-turning sealing ring will be tightly attached to the face when inhaling, and the outwardly-turning sealing ring may loosen and leak some exhaled air when exhaling, but at this time, because the user exhales the exhaust gas, the leakage of some exhaled air does not constitute a breathing risk. The sealing structure 150 shown in FIG. 11 is in a turn-in structure, it is easier to understand the meaning and difference between the turn-in structure and the turn-out structure in combination with FIG. 5 and FIG. 11.

The embodiments of the present disclosure may also provide a breathing assistance system, which may include a gas supply device, a second gas non-return mechanism 240, and any one of the above-mentioned breathing isolation masks 100. Optionally, the first gas tube 130 may be connected to the gas output port of the gas supply device, the second gas non-return mechanism 240 may be installed in the first gas tube 130, and the second gas non-return mechanism 240 may unidirectionally introduce the gas of the gas supply device into the isolation mask body 110.

Optionally, in an optional embodiment of the present disclosure, the gas supply device may comprise an air storage tank for storing purified air or an air purification device. The service time of the portable gas supply device may be limited by the carrying capacity of air tank, or limited by the endurance of power supply or the service life of air filter element. Therefore, the inventor of the present disclosure hopes that the portable air purifier can have a higher utilization rate of purified air.

Optionally, in an optional embodiment of the present disclosure, the breathing assistance system may further comprise a buffer airbag, which may be in communication with the first gas tube 130; and the buffer airbag may be installed in the gas supply device, or may be installed on the other supply tube that may be located between the gas inlet end of the second gas non-return mechanism 240 and the gas supply device, so that the gas generated by the gas supply device can enter the buffer airbag, when the second gas non-return mechanism 240 is closed. In the exhalation phase of the user, the second gas non-return mechanism 240 may be closed, so the buffer airbag can store the purified air released by the air storage tank or generated by the air purification device, and in the inhalation phase, the second gas non-return mechanism 240 may be opened to provide the purified air to users, thereby improving the utilization rate of purified air to a certain extent.

In addition, when the second gas non-return mechanism 240 is closed, the purified air can enter the buffer airbag, and the exhaust gas exhaled by the user will be blocked by the second gas non-return mechanism 240, and will neither flow back into the buffer airbag nor enter the air source to be mixed with the purified air.

Optionally, in an optional embodiment of the present disclosure, the second gas non-return mechanism 240 may comprise a non-return structure, and the non-return structure may be a non-return structure of a swing type structure, or a non-return structure of a piston type structure and the like, the structures shown in FIG. 12 and FIG. 13 may also be adopted.

Optionally, in an optional embodiment of the present disclosure, the buffer airbag may be made of a flexible airtight material. Optionally, in an optional embodiment of the present disclosure, the buffer airbag may be made of an elastic material. Optionally, for example, the buffer airbag may be made of a resin film, or rubber, or a fabric coated with an airtight coating and the like. Optionally, the elastic material may be, for example, latex, rubber, polyurethane, super-material graphene, TPE material, and the like. Optionally, the main body of the buffer airbag may be a film, and some hard connection structures are used to facilitate the connection between the airbag and the tube. Optionally, the buffer airbag may also comprise only the film, for example, adhering or other manners may be used to connect the buffer airbag to the tube, with connected portion being sealed. The use of flexible airtight materials, especially film, enables the buffer airbag to expand without overcoming greater resistance, that is to say, it is easier to inflate the buffer airbag. If the resistance to be overcome during the inflation of the buffer airbag is too large, or even greater than the return force of the non-return structure, the non-return structure may be pushed apart. Of course, the buffer airbag can also be made of rubber film, but the elasticity of the rubber film should not be designed too large.

Optionally, in an optional embodiment of the present disclosure, the breathing assistance system may further comprise a non-elastic protective mask with a preset volume, and the non-elastic protective mask can be provided outside the buffer airbag to limit the maximum expansion volume of the buffer airbag, and the non-elastic protective mask may be made of a breathable or airtight material. Optionally, the non-elastic protective mask may be made of the flexible material such as fabric, or hard material such as plastic. By providing a non-elastic protective mask, the elasticity of the buffer airbag itself may be designed to be relatively small, so that the purified gas is more easily collected by the buffer airbag, and meanwhile, the buffer airbag may be prevented from being stretched and broken.

Optionally, in an optional embodiment of the present disclosure, the breathing assistance system may further comprise a non-elastic airbag with a preset volume, the non-elastic airbag may be accommodated in the buffer airbag, and the non-elastic airbag may be in communication with the first gas tube 130, and the non-elastic airbag may be made of a flexible non-elastic material. Optionally, the non-elastic airbag itself may have no elasticity, so its contraction is achieved with the help of an elastic buffer airbag. Since the non-elastic airbag is arranged in the buffer airbag, the purified gas is actually stored in the non-elastic airbag, and since the maximum volume of the non-elastic airbag is limited, the elastic buffer airbag will not be broken.

The above are only the preferred embodiments of the present disclosure and are not intended to limit the present disclosure, although the present disclosure has been described in detail with reference to the foregoing embodiments, those skilled in the art should understand that the present disclosure can have various modifications and changes. Any modification, equivalent replacement, improvement, and the like made within the spirit and principle of the present disclosure shall be included in the protection scope of the present disclosure.

### INDUSTRIAL APPLICABILITY

For the breathing isolation mask provided by the embodiments of the present disclosure, when in use, the first gas tube on the breathing isolation mask is connected to the gas supply device, and the breathing isolation mask is set on the face to cover only the nose area. Since the first gas tube extends toward two sides of the isolation mask body, and the first gas tube is at least partially connected to at least one of the two straps, so the first gas tube is not suspended below the isolation mask, and especially when the first gas tube is connected to the strap, the first gas tube is more stable, and not prone to swaying and interfering with the original daily activities of a user, or when the first gas tube is optionally embedded in the strap, not only the aforementioned purposes can be achieved, but also it is lighter, simpler and more beautiful.

1. A breathing isolation mask, comprising:
an isolation mask body, wherein the isolation mask body is made of a material capable of isolating gas, and the isolation mask body is provided with at least one inhalation port and an exhalation port, wherein the at least one inhalation port and the exhalation port are independent from one another or are a same port;
a strap group, wherein the strap group at least comprises two straps, and the two straps are respectively connected to two sides of the isolation mask body;
at least one first gas tube, wherein the at least one first gas tube extends towards two sides of the isolation mask body, the at least one first gas tube is at least partially connected to at least one of the two straps, and one end of the at least one first gas tube at least extends to the at least one inhalation port of the isolation mask body; and
a first gas non-return mechanism, wherein the first gas non-return mechanism is mounted on the exhalation port or the at least one first gas tube connected with the at least one inhalation port, and the first gas non-return mechanism is configured to allow gas to unidirectionally exit the isolation mask body from the exhalation port or be discharged from the isolation mask body via the at least one first gas tube connected with the at least one inhalation port.

2. The breathing isolation mask according to claim 1, wherein the strap is in a flexible tubular structure or a belt-like structure, and the at least one first gas tube is at least partially embedded in at least one of the two straps.

3. The breathing isolation mask according to claim 1, wherein the strap is in a flexible mesh structure, and the strap is wound on an outside of the at least one first gas tube.

4. The breathing isolation mask according to claim 1, wherein a cross section of at least one segment of the at least one first gas tube is in a flat shape, and a cross section of a segment of the at least one first gas tube close to the at least one inhalation port is in a flat shape.

5. The breathing isolation mask according to claim 4, wherein the cross section of the segment of the at least one first gas tube close to the at least one inhalation port is elliptical or approximately elliptical.

6. The breathing isolation mask according to claim 5, wherein at least one segment of the at least one first gas tube is provided with at least two gas channels, and the two gas channels are arranged side by side.

7. The breathing isolation mask according to claim 6, wherein at least two first gas tubes are embedded in the same strap, and the two first gas tubes are arranged in parallel to each other.

8. The breathing isolation mask according to claim 7, wherein a part of the strap, from an end close to the isolation mask body to a position at a preset distance away from the isolation mask body, is wrapped outside the at least one first gas tube; and at the position on the strap which is at the preset distance away from the isolation mask body, the at least one first gas tube extends out of the strap.

9. The breathing isolation mask according to claim 8, wherein the isolation mask body is made of an airtight hard material or soft material or a combination of the two materials.

10. The breathing isolation mask according to claim 9, wherein the isolation mask body only covers a nose area.

11. The breathing isolation mask according to claim 10, wherein the breathing isolation mask further comprises at least one second gas tube, multiple first gas tubes are provided, and the at least one second gas tube is connected to the first gas tubes.

12. The breathing isolation mask according to claim 11, wherein an edge of the isolation mask body is connected with a circle of an elastic soft sealing structure.

13. The breathing isolation mask according to claim 12, wherein the sealing structure is a turn-out structure.

14. (canceled)

15. The breathing isolation mask according to claim 13, wherein the at least one inhalation port and the exhalation port are the same port, the isolation mask body is connected to the at least one first gas tube through the same port, and the first gas non-return mechanism is mounted at one end of the at least one first gas tube close to the isolation mask body, so that the gas unidirectionally exits the isolation mask body.

16. The breathing isolation mask according to claim 15, wherein the first gas non-return mechanism comprises a first non-return body and a second non-return body; an elastic modulus of the first non-return body is greater than an elastic modulus of the second non-return body, and optionally, the first non-return body is made of a rigid material, and the second non-return body is made of a flexible material;
the first non-return body is provided with at least one first through hole, and the second non-return body is provided with at least one second through hole; and
when the gas flows in a different direction, at least part of the first non-return body and at least part of the second non-return body move relative to each other,
wherein when the gas flows in a direction of exiting the isolation mask body, a gap is formed between the first non-return body and the second non-return body, and the gap is in communication with the at least one first through hole and the at least one second through hole, to enable the gas to be discharged from the isolation mask body; and
when the gas flows in a direction of flowing into the isolation mask body, all of the at least one first through hole is blocked by the second non-return body, and/or all of the at least one second through hole is blocked by the first non-return body.

17. A breathing assistance system, wherein the breathing assistance system comprises a gas supply device, a second gas non-return mechanism, and the breathing isolation mask according to claim 1, the at least one first gas tube is connected to a gas output port of the gas supply device, the second gas non-return body is mounted at the at least one first gas tube, and the second gas non-return mechanism is configured to unidirectionally introduce gas of the gas supply device into the isolation mask body.

18. The breathing assistance system according to claim 17, wherein the gas supply device comprises an air storage tank configured for storing purified air or an air purification device.

19. The breathing assistance system according to claim 18, wherein the breathing assistance system further comprises a buffer airbag, which is in communication with the at least one first gas tube; and the buffer airbag is mounted on the gas supply device, or mounted on another supply tube located between a gas inlet end of the second gas non-return mechanism and the gas supply device, so that when the second gas non-return mechanism is closed, the gas discharged from the gas supply device enters the buffer airbag.

20. (canceled)

21. (canceled)

22. The breathing assistance system according to claim 19, wherein the breathing assistance system further comprises a non-elastic protective mask with a preset volume, the non-elastic protective mask is sleeved outside the buffer airbag to limit a maximum expansion volume of the buffer airbag, and the non-elastic protective mask is made of a breathable or airtight material.

23. The breathing assistance system according to claim 19, wherein the breathing assistance system further comprises a non-elastic airbag with a preset volume, the non-elastic airbag is accommodated in the buffer airbag, the non-elastic airbag is in communication with the at least one first gas tube, and the non-elastic airbag is made of a flexible non-elastic material.
